(19) United States
(12) Patent Application Publication
(10) Pub. No.: US 2013/0241296 A1
(43) Pub. Date: Sep. 19, 2013

(54) SWITCHING VOLTAGE REGULATOR WITH MULTIPLE POWER INPUT TERMINALS AND RELATED POWER CONVERTER

(71) Applicant: RICHTEK TECHNOLOGY CORPORATION, Zhubei City (TW)

(72) Inventor: Nien-Hui KUNG, Hsinchu City (TW)

(73) Assignee: RICHTEK TECHNOLOGY CORPORATION, Zhubei City (TW)

(21) Appl. No.: 13/777,611

(22) Filed: Feb. 26, 2013

(30) Foreign Application Priority Data
Mar. 19, 2012 (TW) 101204935

(51) Int. Cl. H02J 1/00

(52) U.S. Cl. CPC H02J 1/00
USPC 307/80

(57) ABSTRACT

A switching voltage regulator for a power converter is disclosed. The power converter includes a power source selector, a regulator controller, and an inductor. The switching voltage regulator includes: a first power input terminal; a second power input terminal; a first switch having a first terminal coupled with the first power input terminal; a second switch having a first terminal coupled with the second power input terminal; a third switch having a first terminal coupled with a second terminal of the first switch and a second terminal of the second switch; and a fourth switch having a first terminal, coupled with a second terminal of the third switch, for coupling with the inductor. Control terminals of the first switch and the second switch are utilized for coupling with the power source selector. Control terminals of the third switch and the fourth switch are utilized for coupling with the regulator controller.

### CROSS-REFERENCE TO RELATED APPLICATIONS

This application claims the benefit of priority to Patent Application No. 101204935, filed in Taiwan on Mar. 19, 2012; the entirety of which is incorporated herein by reference for all purposes.

### BACKGROUND

The disclosure generally relates to a switching voltage regulator and, more particularly, to a switching voltage regulator with multiple power input terminals and related power converter.

A switching voltage regulator usually comprises an upper switch and a lower switch to receive corresponding control signals from a regulator controller. In a conventional power converter with multiple power input terminals, upper switches corresponding to different power sources should be arranged in different power input paths of the switching voltage regulator, such as that illustrated in U.S. Pat. No. 7,777,455.

Therefore, if the number of power input terminals of the power converter increases, the number of required upper switches of the switching voltage regulator should be increased as well, thereby occupying more circuit areas and increasing circuit cost.

### SUMMARY

In view of the foregoing, it can be appreciated that a substantial need exists for a switching voltage regulator that can support multiple power input terminals and reduce required circuit area.

An example embodiment of a switching voltage regulator with multiple power input terminals for a power converter is disclosed. The power converter comprises a power source selector, a regulator controller, and an inductor. The switching voltage regulator comprises: a first power input terminal; a second power input terminal; a first switch having a first terminal coupled with the first power input terminal; a second switch having a first terminal coupled with the second power input terminal; a third switch having a first terminal coupled with a second terminal of the first switch and a second terminal of the second switch; and a fourth switch having a first terminal coupled with a second terminal of the third switch and for coupling with the inductor; wherein a control terminal of the first switch and a control terminal of the second switch are utilized for coupling with the power source selector, and a control terminal of the third switch and a control terminal of the fourth switch are utilized for coupling with the regulator controller.

Another example embodiment of a switching voltage regulator with multiple power input terminals for a power converter is disclosed. The power converter comprises a regulator controller and an inductor. The switching voltage regulator comprises: a first power input terminal; a second power input terminal; a first switch having a first terminal coupled with the first power input terminal; a second switch having a first terminal coupled with the second power input terminal; a third switch having a first terminal coupled with a second terminal of the first switch and a second terminal of the second switch; a fourth switch having a first terminal coupled with a second terminal of the third switch and for coupling with the inductor; and a power source selector coupled with a control terminal of the first switch and a control terminal of the second switch to control operations of the first switch and the second switch; wherein a control terminal of the third switch and a control terminal of the fourth switch are utilized for coupling with the regulator controller.

Another example embodiment of a switching voltage regulator with multiple power input terminals for a power converter is disclosed. The power converter comprises a power source selector and a regulator controller. The switching voltage regulator comprises: a first power input terminal; a second power input terminal; a first switch having a first terminal coupled with the first power input terminal; a second switch having a first terminal coupled with the second power input terminal; a third switch having a first terminal coupled with a second terminal of the first switch and a second terminal of the second switch; a fourth switch having a first terminal coupled with a second terminal of the third switch; and an inductor having a first terminal coupled between the third switch and the fourth switch, and a second terminal of the inductor being utilized for providing an output voltage; wherein a control terminal of the third switch and a control terminal of the fourth switch are utilized for coupling with the regulator controller.

Another example embodiment of a power converter is disclosed, comprising: a first power input terminal; a second power input terminal; a first switch having a first terminal coupled with the first power input terminal; a second switch having a first terminal coupled with the second power input terminal; a third switch having a first terminal coupled with a second terminal of the first switch and a second terminal of the second switch; a fourth switch having a first terminal coupled with a second terminal of the third switch; a power source selector coupled with a control terminal of the first switch and a control terminal of the second switch to control operations of the first switch and the second switch; a regulator controller coupled with a control terminal of the third switch and a control terminal of the fourth switch to control operations of the third switch and the fourth switch; and an inductor having a first terminal coupled between the third switch and the fourth switch, and a second terminal of the inductor being utilized for providing an output voltage; wherein when the third switch turns on, the fourth switch turns off, and when the fourth switch turns on, the third switch turns off.

One of the advantages of the above mentioned switching voltage regulator is that the required circuit area for supporting multiple power input terminals can be effectively reduced.

### BRIEF DESCRIPTION OF THE DRAWINGS

FIGS. 1˜3 show simplified functional block diagrams of a power converter according to several embodiments of the present disclosure.

### DETAILED DESCRIPTION

Reference is made in detail to embodiments of the invention, which are illustrated in the accompanying drawings. The same reference numbers may be used throughout the drawings to refer to the same or like parts, components, or operations. Throughout the description and claims, the term “element” contains the concept of component, layer, or region.

Certain terms are used throughout the description and the claims to refer to particular components. One skilled in the art appreciates that a component may be referred to as different names. This disclosure does not intend to distinguish between components that differ in name but not in function. In the description and in the claims, the term “comprise” is used in an open-ended fashion, and thus should be interpreted to mean “include, but not limited to . . . .” Also, the phrase “coupled” with is intended to compass any indirect or direct connection. Accordingly, if this disclosure mentioned that a first device is coupled with a second device, it means that the first device may be directly or indirectly connected to the second device through electrical connections, wireless communications, optical communications, or other signal connections with/without other intermediate devices or connection means.

The term “and/or” may comprise any and all combinations of one or more of the associated listed items. In addition, the singular forms “a”, “an”, and “the” herein are intended to comprise the plural forms as well, unless the context clearly indicates otherwise.

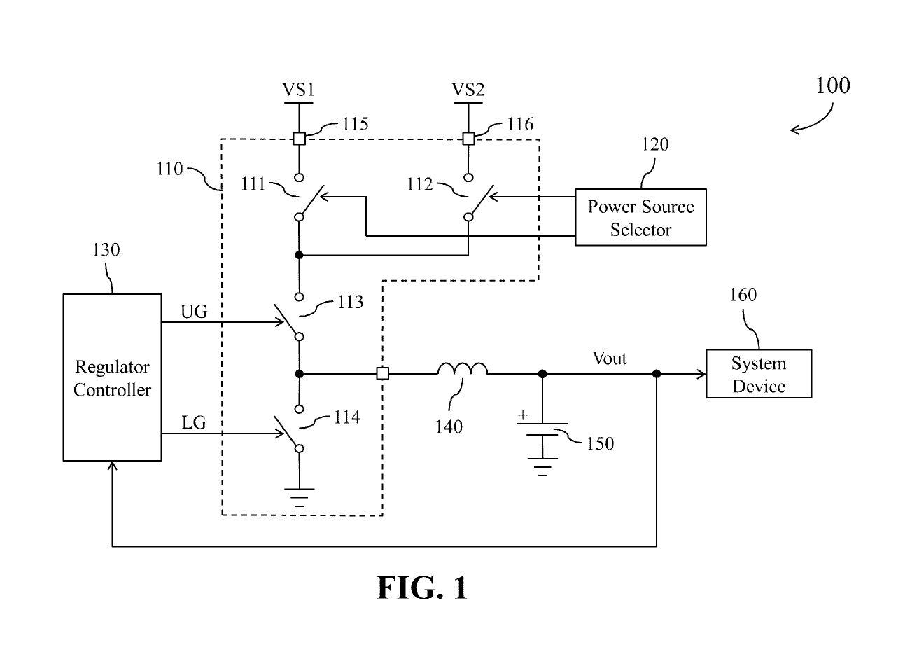

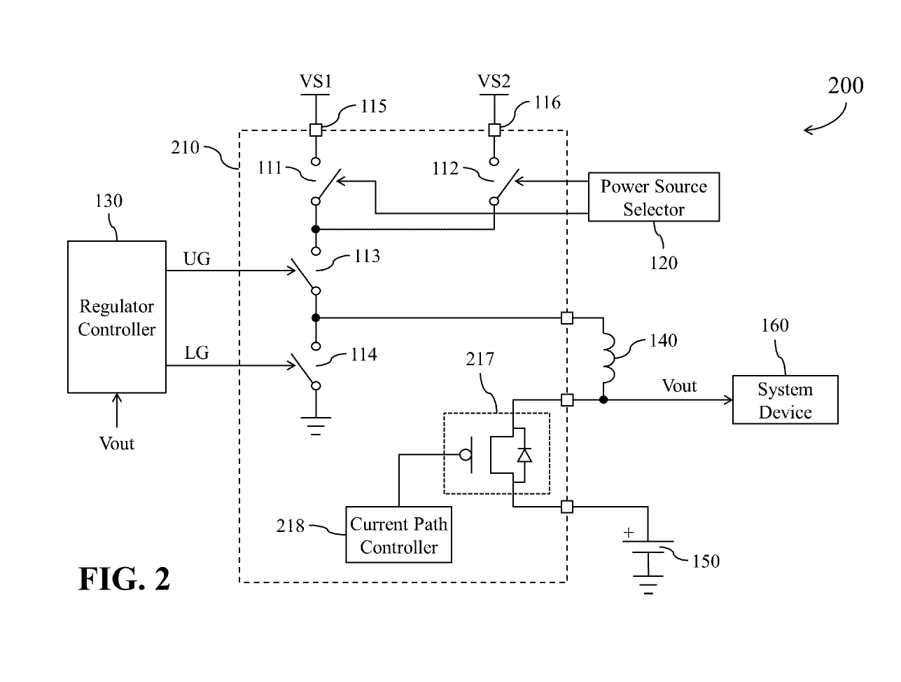

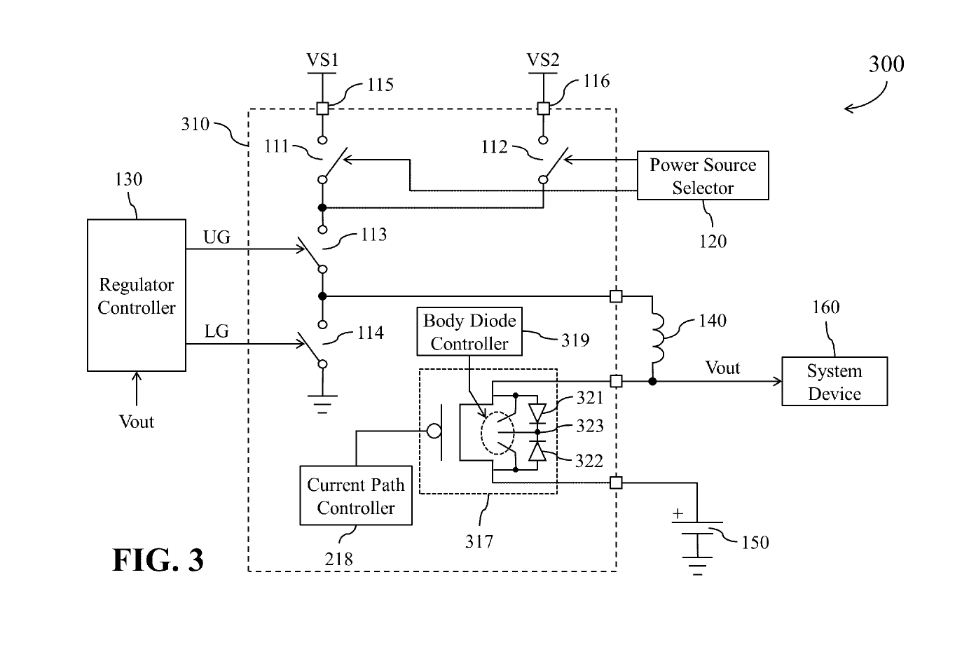

FIG. 1 shows a simplified functional block diagram of a power converter 100 with two power input terminals according to an embodiment of the present disclosure. The power converter 100 comprises a switching voltage regulator 110, a power source selector 120, a regulator controller 130, and an inductor 140. In operations, the power converter 100 may receive electricity from one of two different power sources VS1 and VS2 and convert the received electricity into an appropriate voltage Vout to supply to an external battery 150 and a system device 160.

In the embodiment shown in FIG. 1, the switching voltage regulator 110 comprises a first switch 111, a second switch 112, a third switch 113, a fourth switch 114, a first power input terminal 115, and a second power input terminal 116. A first terminal of the switch 111 is coupled with the power input terminal 115. A first terminal of the switch 112 is coupled with the power input terminal 116. The switch 113 is utilized as an upper switch, and a first terminal of the switch 113 is coupled with a second terminal of the switch 111 and a second terminal of the switch 112. The switch 114 is utilized as a lower switch. A first terminal of the switch 114 is coupled with a second terminal of the switch 113 and a second terminal of the switch 114 is coupled with a fixed-voltage terminal (such as a grounded terminal). The power input terminal 115 is utilized for coupling with the first power source VS1, and the power input terminal 116 is utilized for coupling with the second power source VS2. In implementations, each of the switches 111˜114 may be implemented by a P-type field effect transistor or an N-type field effect transistor. The power source VS1 and the power source VS2 may be two different DC power sources (e.g., USB power sources, batteries, or rectifiers with DC output).

In the power converter 100, the power source selector 120 is coupled with a control terminal of the switch 111 and a control terminal of the switch 112 to control operations of the switch 111 and the switch 112 so as to select a source of voltage to be processed by the switching voltage regulator 110. The regulator controller 130 is coupled with control terminals of the switch 113 and the switch 114 to control operations of the switch 113 and the switch 114. A first terminal of the inductor 140 is coupled between the switch 113 and the switch 114, and a second terminal of the inductor 140 is utilized for coupling with the external battery 150 and for providing an output voltage Vout.

In operations, the power source selector 120 detects power reception statuses of the power input terminals 115 and 116 and accordingly controls the operations of the switches 111 and 112 to select the source of voltage to be processed by the switching voltage regulator 110. For example, when the power source selector 120 has detected a presence of input power at the power input terminal 115 and an absence of input power at the power input terminal 116, the power source selector 120 turns on the switch 111 and turns off the switch 112. On the contrary, when the power source selec- tor 120 has detected a presence of input power at the power input terminal 116 and an absence of input power at the power input terminal 115, the power source selector 120 turns on the switch 112 and turns off the switch 111. When the power source selector 120 has detected a presence of input power at the power input terminal 115 and a presence of input power at the power input terminal 116, the power source selector 120 may select one of the two power sources VS1 and VS2 as the source of voltage to be processed by the switching voltage regulator 110 according to a default priority configuration of the power sources VS1 and VS2 or according to a users' configuration.

The regulator controller 130 performs a feedback control on the output voltage Vout of the power converter 100 to generate control signals UG and LG for controlling the switch 113 and the switch 114. In this embodiment, when the regulator controller 130 turns on the switch 113, the regulator controller 130 turns the switch 114 off; and when the regulator controller 130 turns on the switch 114, the regulator controller 130 turns the switch 113 off.

When the power source selector 120 turns on the switch 111, the switch 113 and the switch 114 of the switching voltage regulator 110 are alternately switched under the control of the control signals UG and LG to cooperate with the inductor 140 to convert the voltage received by the power input terminal 115 into the output voltage Vout. When the power source selector 120 turns on the switch 112, the switching voltage regulator 110 cooperates with the inductor 140 to convert the voltage received by the power input terminal 116 into the output voltage Vout under the control of the regulator controller 130.

In the embodiment shown in FIG. 1, the power converter 100 may charge the external battery 150 with the output voltage Vout and simultaneously supply power to the subsequent system device 160.

In implementations, any one, any two, or all of the power source selector 120, the regulator controller 130, and the inductor 140 may be integrated into the switching voltage regulator 110.

FIG. 2 shows a simplified functional block diagram of a power converter 200 with two power input terminals according to another embodiment of the present disclosure. The power converter 200 comprises a switching voltage regulator 210, the power source selector 120, the regulator controller 130, and the inductor 140. The power converter 200 may receive electricity from one of the two different power sources VS1 and VS2 and convert the received electricity into an appropriate voltage Vout to supply to the external battery 150 and the system device 160.

As shown in FIG. 2, the switching voltage regulator 210 of the power converter 200 is similar to the switching voltage regulator 110 shown in FIG. 1. The difference between the two embodiments is that the switching voltage regulator 210 further comprises a fifth switch 217 and a current path controller 218. A first terminal of the switch 217 is coupled with the second terminal of the inductor 140 and a second terminal of the switch 217 is utilized for coupling with the external battery 150. The current path controller 218 is coupled with a control terminal of the switch 217 to control an operation of the switch 217. In implementations, the switch 217 may be realized by a P-type field effect transistor, an N-type field effect transistor, or any other kind of transistor architectures.

In the embodiment shown in FIG. 2, the switch 217 is coupled between the inductor 140 and the external battery 150. Accordingly, when the power converter 200 supplies power to the system device 160, the current path controller 218 may decide whether to control the power converter 200 to simultaneously charge the external battery 150 by switching the switch 217. For example, when the current path controller 218 turns on the switch 217, the power converter 200 is allowed to charge the external battery 150 and simultaneously supply power to the system device 160. When the current path controller 218 turns off the switch 217, the power converter 200 would not charge the external battery 150 while supplying power to the system device 160.

In implementations, any one, any two, or all of the power source selector 120, the regulator controller 130, and the inductor 140 may be integrated into the switching voltage regulator 210.

The descriptions regarding the implementations and operations of the other function blocks of the power converter 100 in the embodiment shown in FIG. 1 are also applicable to the power converter 200 shown in FIG. 2. For simplicity, the descriptions will not be repeated here.

FIG. 3 shows a simplified functional block diagram of a power converter 300 with two power input terminals according to another embodiment of the present disclosure. The power converter 300 comprises a switching voltage regulator 310, the power source selector 120, the regulator controller 130, and the inductor 140. The power converter 300 may receive electricity from one of the two different power sources VS1 and VS2 and convert the received electricity into an appropriate voltage Vout to supply to the external battery 150 and the system device 160.

As shown in FIG. 3, the switching voltage regulator 310 of the power converter 300 is similar to the switching voltage regulator 110 shown in FIG. 1. The difference between the two embodiments is that the switching voltage regulator 310 further comprises a sixth switch 317, the current path controller 218, and a body diode controller 319. A first terminal of the switch 317 is coupled with the second terminal of the inductor 140 and a second terminal of the switch 317 is coupled with the external battery 150. The switch 317 comprises a first body diode 321 and a second body diode 322. The body diode 321 is coupled between the first terminal of the switch 317 and a first node 323, and the body diode 322 is coupled between the second terminal of the switch 317 and the first node 323. The current path controller 218 is coupled with a control terminal of the switch 317 to control operations of the switch 317. In implementations, the switch 317 may be realized by a P-type field effect transistor, an N-type field effect transistor, or any other kind of transistor architectures.

The switch 317 is coupled between the inductor 140 and the external battery 150. Accordingly, when the power converter 300 supplies power to the system device 160, the current path controller 218 may decide whether to control the power converter 300 to simultaneously charge the external battery 150 by switching the switch 317. For example, when the current path controller 218 turns on the switch 317, the power converter 300 is allowed to charge the external battery 150 and simultaneously supply power to the system device 160. When the current path controller 218 turns off the switch 317, the power converter 300 would not charge the external battery 150 while supplying power to the system device 160.

The body diode controller 319 is coupled with the switch 317 and utilized for selectively coupling the node 323 with the first terminal of the switch 317 or the second terminal of the switch 317. The body diode 321 is configured as active and the body diode 322 is configured as inactive when the body diode controller 319 couples the node 323 with the second terminal of the switch 317. In this status, an equivalent diode characteristic of the switch 317 is determined by the body diode 321.

On the contrary, the body diode 322 is configured as active and the body diode 321 is configured as inactive when the body diode controller 319 couples the node 323 with the first terminal of the switch 317. In this status, the equivalent diode characteristic of the switch 317 is determined by the body diode 322.

Accordingly, when the current path controller 218 turns on the switch 317 and the body diode controller 319 couples the node 323 with the second terminal of the switch 317, a reverse bias voltage characteristic of the body diode 321 prevents a leakage current of the charging external battery 150 from flowing to the inductor 140 through the switch 317. In this way, it is allowed to avoid reduction of charging efficiency of the external battery 150 incurred by the leakage current.

On the other hand, when the current path controller 218 turns off the switch 317 and the body diode controller 319 couples the node 323 with the second terminal of the switch 317, the reverse bias voltage characteristic of the body diode 321 prevents a leakage current of the idle external battery 150 from flowing to the inductor 140 through the switch 317. In this way, it is allowed to prevent reduction of charges which are stored in the idle external battery 150 incurred by the leakage current.

In implementations, any one, any two, or all of the power source selector 120, the regulator controller 130, and the inductor 140 may be integrated into the switching voltage regulator 310.

The descriptions regarding the implementations and operations of the other function blocks of the power converter 100 in the embodiment shown in FIG. 1 are also applicable to the power converter 300 shown in FIG. 3. For simplicity, the descriptions will not be repeated here.

It can be appreciated from the foregoing descriptions that each of the switching voltage regulators disclosed in the previous embodiments is capable of supporting two power input terminals by employing only one upper switch 113. Thus, the required circuit area of the switching voltage regulator for supporting multiple power input terminals can be effectively reduced. In addition, the functionality of the aforementioned structure where a single upper switch 113 is shared by two power input paths can be extended by utilizing the power source selector 120 to cooperate with a sufficient number of power selection switches in order to support the applications with more power input terminals. In this situation, the required circuit area can be further reduced.

Other embodiments of the invention will be apparent to those skilled in the art from consideration of the specification and practice of the invention disclosed herein. It is intended that the specification and examples be considered as exemplary only, with a true scope and spirit of the invention indicated by the following claims.

What is claimed is:

1. A switching voltage regulator with multiple power input terminals for a power converter, the power converter comprising a power source selector, a regulator controller, and an inductor, the switching voltage regulator comprising:
a first power input terminal;
a second power input terminal;
a first switch having a first terminal coupled with the first power input terminal;
a second switch having a first terminal coupled with the second power input terminal;
a third switch having a first terminal coupled with a second terminal of the first switch and a second terminal of the second switch; and
a fourth switch having a first terminal coupled with a second terminal of the third switch and for coupling with the inductor;
wherein a control terminal of the first switch and a control terminal of the second switch are utilized for coupling with the power source selector, and a control terminal of the third switch and a control terminal of the fourth switch are utilized for coupling with the regulator controller.

2. The switching voltage regulator of claim 1, further comprising:
a fifth switch for coupling between the inductor and an external battery; and
a current path controller coupled with a control terminal of the fifth switch to control operations of the fifth switch.

3. The switching voltage regulator of claim 1, further comprising:
a sixth switch for coupling between the inductor and an external battery, and the sixth switch comprises a first body diode and a second body diode, wherein the first body diode is coupled between a first terminal of the sixth switch and a first node, and the second body diode is coupled between a second terminal of the sixth switch and the first node;
a current path controller coupled with a control terminal of the sixth switch to control operations of the sixth switch; and
a body diode controller for selectively coupling the first node with the first terminal of the sixth switch or the second terminal of the sixth switch.

4. A switching voltage regulator with multiple power input terminals for a power converter, the power converter comprising a regulator controller and an inductor, the switching voltage regulator comprising:
a first power input terminal;
a second power input terminal;
a first switch having a first terminal coupled with the first power input terminal;
a second switch having a first terminal coupled with the second power input terminal;
a third switch having a first terminal coupled with a second terminal of the first switch and a second terminal of the second switch;
a fourth switch having a first terminal coupled with a second terminal of the third switch and for coupling with the inductor; and
a power source selector coupled with a control terminal of the first switch and a control terminal of the second switch to control operations of the first switch and the second switch;
wherein a control terminal of the third switch and a control terminal of the fourth switch are utilized for coupling with the regulator controller.

5. The switching voltage regulator of claim 4, further comprising:
a fifth switch for coupling between the inductor and an external battery; and
a current path controller coupled with a control terminal of the fifth switch to control operations of the fifth switch.

6. The switching voltage regulator of claim 4, further comprising:
a sixth switch for coupling between the inductor and an external battery, and the sixth switch comprises a first body diode and a second body diode, wherein the first body diode is coupled between a first terminal of the sixth switch and a first node, and the second body diode is coupled between a second terminal of the sixth switch and the first node;
a current path controller coupled with a control terminal of the sixth switch to control operations of the sixth switch; and
a body diode controller for selectively coupling the first node with the first terminal of the sixth switch or the second terminal of the sixth switch.

7. A switching voltage regulator with multiple power input terminals for a power converter, the power converter comprising a power source selector and a regulator controller, the switching voltage regulator comprising:
a first power input terminal;
a second power input terminal;
a first switch having a first terminal coupled with the first power input terminal;
a second switch having a first terminal coupled with the second power input terminal;
a third switch having a first terminal coupled with a second terminal of the first switch and a second terminal of the second switch;
a fourth switch having a first terminal coupled with a second terminal of the third switch; and
an inductor having a first terminal coupled between the third switch and the fourth switch, and a second terminal of the inductor being utilized for providing an output voltage;
wherein a control terminal of the third switch and a control terminal of the fourth switch are utilized for coupling with the regulator controller.

8. The switching voltage regulator of claim 7, further comprising:
a fifth switch for coupling between the inductor and an external battery; and
a current path controller coupled with a control terminal of the fifth switch to control operations of the fifth switch.

9. The switching voltage regulator of claim 7, further comprising:
a sixth switch for coupling between the inductor and an external battery, and the sixth switch comprises a first body diode and a second body diode, wherein the first body diode is coupled between a first terminal of the sixth switch and a first node, and the second body diode is coupled between a second terminal of the sixth switch and the first node;
a current path controller coupled with a control terminal of the sixth switch to control operations of the sixth switch; and
a body diode controller for selectively coupling the first node with the first terminal of the sixth switch or the second terminal of the sixth switch.

10. A power converter, comprising:
a first power input terminal;
a second power input terminal;
a first switch having a first terminal coupled with the first power input terminal;
a second switch having a first terminal coupled with the second power input terminal;
a third switch having a first terminal coupled with a second terminal of the first switch and a second terminal of the second switch;
a fourth switch having a first terminal coupled with a second terminal of the third switch;
a power source selector coupled with a control terminal of the first switch and a control terminal of the second switch to control operations of the first switch and the second switch;
a regulator controller coupled with a control terminal of the third switch and a control terminal of the fourth switch to control operations of the third switch and the fourth switch; and
an inductor having a first terminal coupled between the third switch and the fourth switch, and a second terminal of the inductor being utilized for providing an output voltage;
wherein when the third switch turns on, and the fourth switch turns off, and when the fourth switch turns on, and the third switch turns off.

11. The power converter of claim 10, further comprising:
a fifth switch for coupling between the inductor and an external battery; and
a current path controller coupled with a control terminal of the fifth switch to control operations of the fifth switch.

12. The power converter of claim 10, further comprising:
a sixth switch for coupling between the inductor and an external battery, and the sixth switch comprises a first body diode and a second body diode, wherein the first body diode is coupled between a first terminal of the sixth switch and a first node, and the second body diode is coupled between a second terminal of the sixth switch and the first node;
a current path controller coupled with a control terminal of the sixth switch to control operations of the sixth switch; and
a body diode controller for selectively coupling the first node with the first terminal of the sixth switch or the second terminal of the sixth switch.
